(19) United States
(12) Patent Application Publication
(10) Pub. No.: US 2019/0144242 A1
(43) Pub. Date: May 16, 2019

(54) NON-CONTACT CHARGING SYSTEM FOR ELEVATOR

(71) Applicant: KABUSHIKI KAISHA TOSHIBA, Tokyo (JP)

(72) Inventor: Tetsu Shijo, Setagaya Tokyo (JP)

(21) Appl. No.: 15/916,850

(22) Filed: Mar. 9, 2018

(30) Foreign Application Priority Data
Nov. 16, 2017 (JP) 2017-221032

(51) Int. Cl. B66B 7/06; H02J 7/02; H02J 50/12; H01F 38/14; H02J 50/70; H01F 27/36; H01B 7/00; H01B 9/02; B66B 11/02; B66B 1/34; B66B 5/00; B66B 5/02

(52) U.S. Cl. CPC B66B 7/064; H02J 7/025; H02J 50/12; H01F 38/14; H02J 50/70; H01F 27/365; H01F 27/24; H01B 9/02; B66B 11/0226; B66B 1/3446; B66B 5/0018; B66B 5/021; H01B 7/0009

(57) ABSTRACT

According to one embodiment, a non-contact charging system for an elevator includes a secondary battery, a power receiving pad, a rectifier circuit and a first capacitor. The secondary battery is located in an upper part of a cage. The power receiving pad is located in a bottom part of the cage. The rectifier circuit is connected between the power receiving pad and the secondary battery. The first capacitor is connected between the power receiving pad and the rectifier circuit, located in the bottom part of the cage.

### CROSS-REFERENCE TO RELATED APPLICATIONS

This application is based upon and claims the benefit of priority from Japanese Patent Application No. 2017-221032, filed on Nov. 16, 2017; the entire contents of which are hereby incorporated by reference.

### FIELD

Embodiments described herein relate generally to a non-contact charging system for elevator.

### BACKGROUND

Devices such as lights, air conditioners, displays, operation consoles, door motors or the like are implemented in elevator cages. Therefore, some electric power needs to be provided to the elevator cages. Large cables called the tail cords are connected to the elevator cages for providing electricity and enabling communication of signals. The weight of the tail cords reaches a few metric tons for skyscrapers and high-rise apartments. Thus, increased consumption of energy by the elevators, higher construction costs and difficulty of maintenance tasks are becoming problems.

Recently, technology for charging secondary batteries implemented in the elevator cages by using non-contact power supply (wireless power supply) is being developed. Non-contact power supply technology has been used for limited purposes such as the emergency power during electricity outages. However, applications for providing power during regular operations are being considered. In order to apply the technology to elevator systems, the reduction of cost, preventing of exposure of electromagnetic waves to passengers, reduction of electromagnetic noise, keeping safety when the elevator system is inundated with water, or the like are requirements.

### BRIEF DESCRIPTION OF THE DRAWINGS

FIG. 1 is a diagram showing components of a non-contact charging system according to a first embodiment;

FIG. 2 is a diagram showing a power transmission device according to the first embodiment;

FIG. 3 is a diagram showing a power receiving device according to the first embodiment;

FIG. 4 is a diagram showing a circuit of the non-contact charging system;

FIG. 5 is diagram showing a perspective view of an elevator cage;

FIG. 6 is diagram showing a configuration of the elevator cage according to the first embodiment;

FIG. 7 is a diagram showing a multi-core cable;

FIG. 8 is a diagram showing an example of the surface where the power receiving pad is located from a perspective view;

FIG. 9 is a diagram showing an example of the surface where the power receiving pad is located from a perspective view;

FIG. 10 is a diagram showing an example of the surface where the power receiving pad is located from a perspective view;

FIG. 11 is a diagram showing a first example of a power transmission pad and a power receiving pad;

FIG. 12 is a diagram showing a second example of a power transmission pad and a power receiving pad;

FIG. 13 is a diagram showing a configuration of an elevator cage according to a second embodiment;

FIG. 14 is a diagram showing a configuration of a non-contact charging system according to a third embodiment;

FIG. 15 is a diagram showing a configuration of an elevator cage according to a fourth embodiment;

FIG. 16 is a diagram showing a configuration of an elevator cage according to a fifth embodiment.

### DETAILED DESCRIPTION

According to one embodiment, a non-contact charging system for an elevator includes a secondary battery, a power receiving pad, a rectifier circuit and a first capacitor. The secondary battery is located in an upper part of a cage. The power receiving pad is located in a bottom part of the cage. The rectifier circuit is connected between the power receiving pad and the secondary battery. The first capacitor is connected between the power receiving pad and the rectifier circuit, located in the bottom part of the cage.

Hereinafter, embodiments of the present invention will be described in reference to the drawings.

### First Embodiment

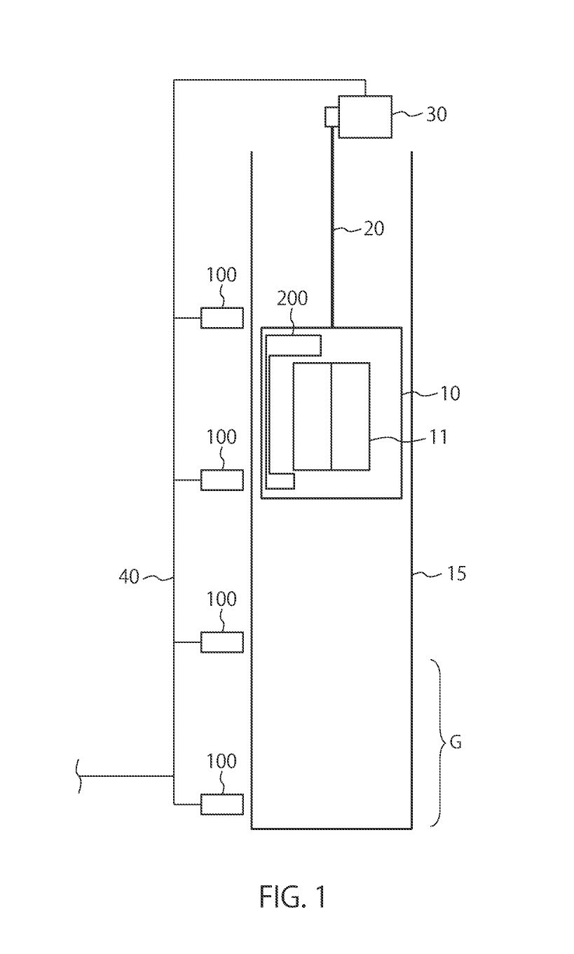

FIG. 1 is a block diagram showing a schematic configuration of a non-contact charging system according to a first embodiment. The non-contact charging system according to the first embodiment will be described in reference to FIG. 1.

The non-contact charging system according to the embodiment includes a cage 10, a hoistway 15, a rope 20, a hoisting machine 30, a power cable 40 and a power transmission device 100. The cage 10 includes a door 11 and a power receiving device 200 as internal components.

The cage 10 which is located in the hoistway 15 is connected to the hoisting machine 30 via the rope 20. The elevating operation of the cage 10 is driven by the hoisting machine 30. The door 11 located on the cage 10 can open and close. When the door 11 is opened, passengers, equipment, goods or the like can enter and exit the room within the cage 10. The power receiving device 200 located on the cage 10 can receive power from the power transmission device 100 without any physical contact.

Devices such as lights, air conditioning systems, communication devices, speakers, displays, operation consoles, door motors or the like (not shown) can operate using the electric power stored in the power receiving device 200. These devices are only examples. Therefore, other devices can be implemented in the cage 10. Also, the cage 10 does not need to have all the aforementioned devices. Details of the power receiving device 200 are explained later.

The power transmission device 100 is located so that it faces the internal circumference of the elevator hoistway 15. The power transmission device 100 receives power from the power cable 40. The power transmission device 100 is located in each of the stopping locations of the cage 10, for example. In this case, power is supplied from the power transmission device 100 when the cage 10 is at any of the stopping locations. The stopping locations of the cage 10 are all of the floors or some of the floors in a building. The location of the power transmission device 100 shown in FIG. 1 is only an example. Thus, it is possible to place the power transmission device 100 in a different location. Details on the power transmission device 100 are described later.

The power cable 40 provides electric power to each of the power transmission devices 100 and the hoisting machine 30. The power cable 40 is connected to the power grid of an electric company, for example. The power cable 40 provides electricity of 200V or 400V with three-phase alternating currents, for example. The voltage, the type of alternating current and the destination of connection for the power cable 40 are not limited. For example, the power cable 40 can be connected to a private power generator or an emergency generator. Also, the type of power cable 50 is not limited.

In the hoistway 15 shown in FIG. 1, the lowest part is the first floor G. However, this is only an example. The lowest part of the hoistway 15 can be underground or a floor higher than the first floor. Similarly, the height of the highest part of the hoistway 15 is not limited.

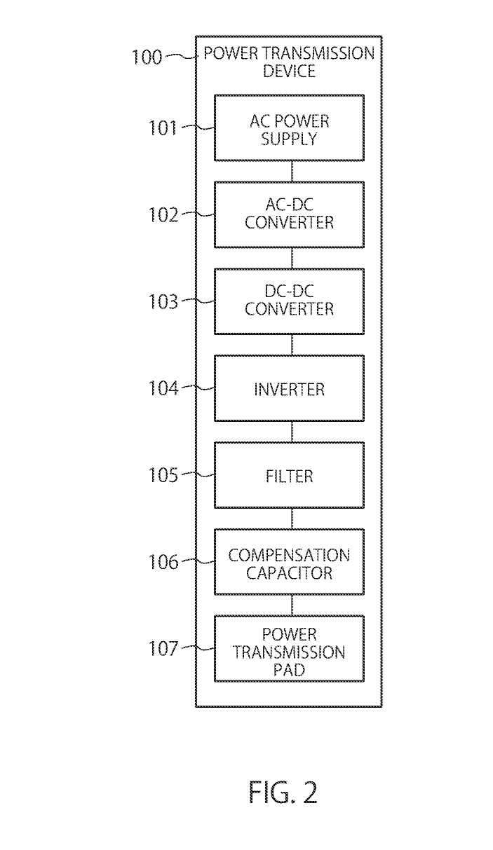

Next, the components of the power transmission device 100 are described. FIG. 2 is a diagram showing a power transmission device according to the first embodiment.

The power transmission device 100 includes an AC power supply 101, an AC-DC converter 102, a DC-DC converter 103, an inverter 104, a filter 105, a compensation capacitor 106 and a power transmission pad 107.

The AC power supply 101 provides AC power to the power transmission device 100. The AC power supply 101 can be electric power provided from electric companies. Also, it can be electric power provided from a private power generator or an emergency generator. Thus, the type of source is not limited.

The AC-DC converter 102 converts AC power provided by the AC power supply 101 to DC power. Types of AC-DC converters 102 include switching converters or converters with transformers. However, any type of converters can be used.

The DC-DC converter 103 boosts or lowers the voltage of the DC power provided from the AC-DC converter 102. If there is no need to change the voltage, the DC-DC converter 103 could be omitted. The required voltage of DC power can be determined based on the transmission efficiency between the power transmission pad 107 and the power receiving pad 201. The required voltage of DC power also depends on the specification of the battery 209.

The inverter 104 converts the DC power to AC power in desired frequencies. The inverter 104 provides AC power of frequencies lower than 200 kHz. Examples of the frequencies include, 9 kHz, 20 kHz, 85 kHz, or the like. However, the values mentioned above are only examples. Thus, the frequency of AC power is not limited. Also, the types of circuits used for the inverter are not limited.

The filter 105 is a low-pass filter which reduces noise components from AC power signals. By using the filter 105, noise components in high frequencies can be reduced. Depending on the conditions of designs, the filter 105 can be omitted. Also, the number of filters 105 can be increased. The location of the filter 105 can be different from the example shown in FIG. 2.

The compensation capacitor 106 is a capacitor which improves the power factor of the AC power. The power factor is the ratio between the effective power and the apparent power. For the sake of efficient power transmission, the reactive power should be set to a small value, making the power factor take values close to 1. Since the power transmission pad 107 is an inductive load, the phase of the voltage becomes delayed compared to the phase of current, generating some reactive power. In such cases, it is possible to use the compensation capacitor 106 to make the difference in the phase smaller. If the difference in the phases of the voltage and the current becomes smaller, the power factor could be improved, making power transmission by the power transmission pad 107 more efficient.

The power transmission pad 107 can provide power to the power receiving pad 201 without physical contacts. Instead, the power transmission pad 107 becomes electromagnetically coupled with the power receiving pad 201. Different types of wireless power supplying devices can be used for the power transmission pad 107, as long as compatibility with the device corresponding to the power receiving pad 201 is maintained. Examples of wireless power supplying methods include electromagnetic induction, magnetic resonance (MR), electric field coupling, and transmission of radio waves or the like. Details in the structure of the power transmission pad 107 are described later.

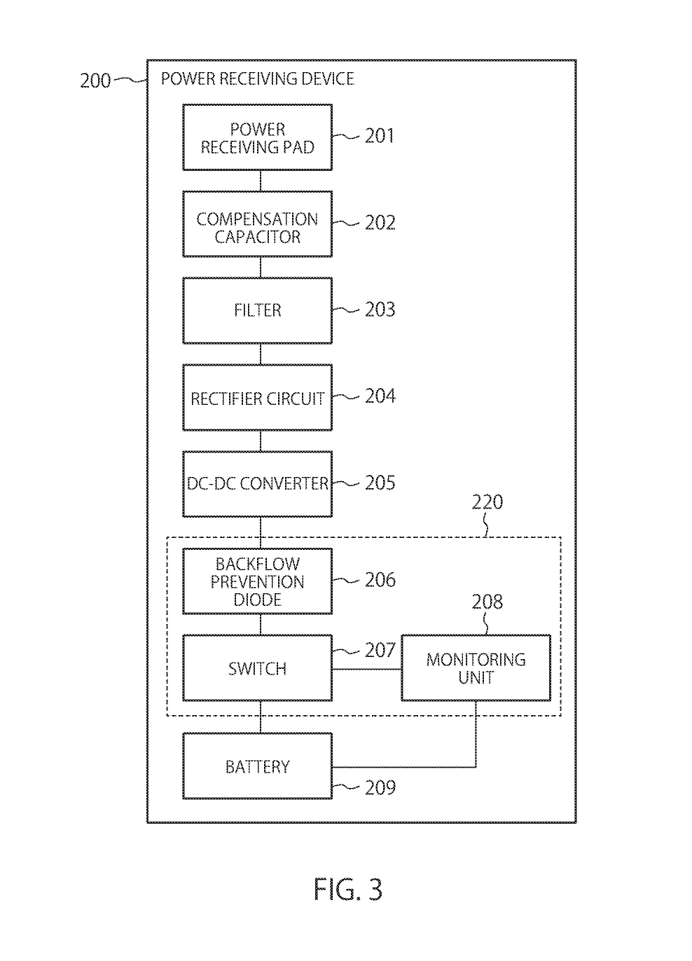

Next, the components of the power receiving device 200 are explained. FIG. 3 is a diagram showing an example of the power receiving device according to the first embodiment.

The power receiving device 200 includes a power receiving pad 201, a compensation capacitor 202, a filter 203, a rectifier circuit 204, a DC-DC converter 205, a backflow prevention diode 206, a switch 207, a monitoring unit 208 and a battery 209. The backflow prevention diode 206, the switch 207 and the monitoring unit 208 are components belonging to a backflow prevention unit 220.

The power receiving pad 201 can receive power transmitted from the power transmission pad 107 by using electromagnetic coupling. Different types of wireless power supplying devices can be used for the power receiving pad 201, as long as compatibility with the device corresponding to the power transmission pad 107 is maintained. Examples of wireless power supplying methods include electromagnetic induction, magnetic resonance (MR), electric field coupling, and transmission of radio waves or the like. Details in the structure of the power receiving pad 201 are described later.

The compensation capacitor 202 is a capacitor which improves the power factor of the AC power. Since the load side observed from the compensation capacitor 202 is generally inductive, some reactive power is generated. Thus, by inserting the compensation capacitor 202, it is possible to reduce the difference between the phases of the voltage and the current. By setting the power factor to a value close to 1, the transmitted power can be received efficiently.

The filter 203 reduces the noise components in the AC power. It is possible to use a low-pass filter as the filter 203, for example. By using a low-pass filter, it is possible to reduce the high frequency noise components. Depending on design conditions, the filter 203 can be omitted. Also, the number of filters 203 could be increased. The location of filter 203 in the electric circuit can be different from the example shown in FIG. 3.

The rectifier circuit 204 rectifies the AC power, providing DC power as the output. Examples of the rectifier circuit 204 include a full-bridge circuit which uses full-wave rectification or a half-bridge circuit which uses half-wave rectification. By using a full-bridge circuit and a half-bridge circuit, it is possible to prevent current from the battery 209 to backflow into the direction of the power receiving pad 201.

The DC-DC converter 205 boosts or lowers the voltage of the DC power provided from the rectifier circuit 204. If there is no need to change the voltage, the DC-DC converter 205 could be omitted. The required voltage of DC power can be determined based the specification of the battery 209.

The backflow prevention unit 220 is located in the ceiling side (upper part) of the cage 10. The backflow prevention unit 220 prevents the backflow of current from the battery 209 into the direction of the power receiving pad 201. Examples of components included in the backflow prevention unit 220 include the backflow prevention diode 206, the switch 207, the monitoring unit 208 or the like. The backflow prevention unit 220 can include all the aforementioned components. The backflow prevention unit 220 can also include only a part of the aforementioned components. The rectifier circuit 204 can also prevent the backflows of current. However, since the rectifier circuit 204 is not always located in the ceiling side(upper part) of the cage 10, the rectifier circuit 204 is not included in the backflow prevention unit 220. Details on the locations of components in the cage 10 are described later.

The backflow prevention diode 206 prevents the current from flowing from the output side to the input side when the voltage in the output side is higher than the voltage in the input side. Thus, by using the backflow prevention diode 206, it is possible to prevent the current to backflow from the battery 209 to the direction of the power receiving pad 201. The type of backflow prevention diode 206 which is used is not limited.

The switch 207 cuts the electrical connection between the battery 209 and the power receiving pad 201, thereby preventing backflow current from the battery 209 to flow into the direction of the power receiving pad 201. It is possible to use different switches including protection relays, breakers or the like as the switch 207. The switch 207 can be implemented using other devices. Thus, the implementation of the switch 207 is not limited. The switch 207 can be opened and closed (turned on and turned off) manually. Also, the switch 207 can operate based on instructions received from the monitoring unit 208. If the switch 207 needs electric power to operate, the power provided from the battery 209 could be used.

The monitoring unit 208 monitors the status of the power receiving device 200. The switch 207 is manipulated based on the result of monitoring. Using measurements from various sensors, the monitoring unit 208 can monitor the status of the power receiving device 200. The monitoring unit 208 can measure the voltage or current of the circuit within the power receiving device 200 to detect anomalies such as short circuits, backflows of current or the like. It is possible to obtain various sensor readings of the secondary battery from the fuel-gauge IC in the battery 209 for the sake of anomaly detection. Also, the switch 207 can be manipulated based on signals obtained from leakage water detectors located in the bottom part of the cage 10. The monitoring unit 208 can operate using the electric power provided from the battery 209.

The features of the monitoring unit 208 can be implemented by using software (programs) operating in the CPU (Central Processing Unit). It is also possible to use hardware circuitry such as FPGA, ASIC or the like to implement the features. A combination of the above can be used as well. The monitoring unit 208 can include a storage unit. Examples of the storage unit include non-volatile storage devices such as NAND flash memory, NOR flash memory, MRAM, ReRAM, hard disks, optical discs or the like. Also, volatile storage devices such as the DRAM or the like can be used. A combination of the aforementioned storage devices can be used, as well.

The battery 209 is a secondary battery which is charged by DC power. Examples of secondary batteries include nickel-metal hydride batteries, lithium ion batteries of the like. The capacity, the rated voltage, the specification or the like of the battery 209 can be determined based on factors such as the devices implemented in the cage 10, driving voltage, consumption of energy or the like. Also, the battery 209 can have a fuel-gauge IC. The timing of charging, the timing of discharging, the current of the battery 209 can be controlled by the fuel-gauge IC. However, the above controlling process can be executed by the monitoring unit 208. Also, the battery 209 can be controlled by instructions from specialized controllers located in the cage 10 or controllers located in outside of the cage 10. Thus, the battery 209 can be controlled by using any method.

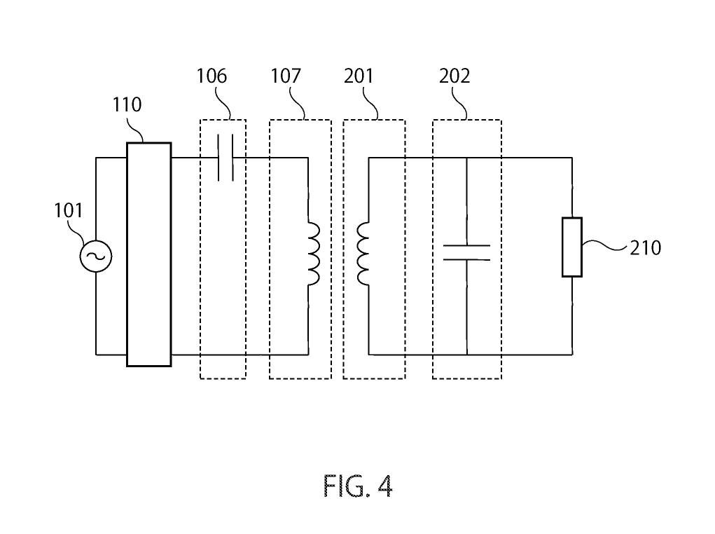

FIG. 4 is a diagram showing a circuit of the non-contact charging system. FIG. 4 shows a configuration of circuits when the power transmission device 100 and the power receiving 200 are facing with each other and the wireless power supply process can be executed. In the following, the circuit shown in FIG. 4 is explained.

The AC power unit 101 provides power to a load 110. The load 110 corresponds to the AC-DC converter 102, the DC-DC converter 103, the inverter 104 and the filter 105. The compensation capacitor 106 improves the power factor of the AC power provided from the load 110. Then, the AC power is provided to the power transmission pad 107. The power transmission pad 107 corresponds to the primary coil in FIG. 4.

The power receiving pad 201 facing the power transmission pad 107 is electromagnetically coupled to the power transmission pad 107. Thus, AC power is transmitted from the power transmission pad 107 to the power receiving pad 201. The power receiving pad 201 corresponds to the secondary coil in FIG. 4. The AC power transmitted to the power receiving pad 201 is applied to the compensation capacitor 202. The compensation capacitor 202 also improves the power factor of the AC power. The AC power in the output of the compensation capacitor 202 is provided to a load 210. The load 210 corresponds to the filter 203, the rectifier circuit 204, the DC-DC converter 205, the backflow prevention diode 206, the switch 207, the monitoring unit 208 and the battery 209.

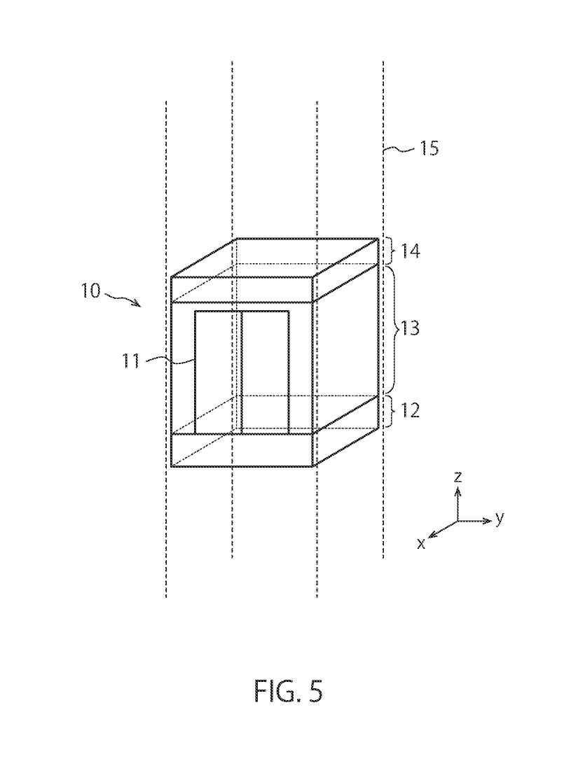

Next, the location of components in the power transmission device 100 and the power receiving device 200 are explained. Before proceeding to the detailed descriptions, the components in the cage 10 of the elevator are explained. FIG. 5 is diagram showing a perspective view of an elevator cage. FIG. 5 shows the cage 10 in simplified form. Therefore, various cables including the rope 20 are not illustrated explicitly in FIG. 5.

The cage 10 can be divided into three parts including a bottom part 12, a central part 13 and an upper part 14. The bottom part 12 is the part located in the ground (z-axis negative) direction to the room of the cage 10. The bottom part 12 has some space within the interior which enables the installation of various devices.

The central part 13 is located between the bottom part 12 and the upper part 14. The central part 13 has a room in the interior. It is possible to enter and exit the room through the door 11. The door 11 is located in one of the surfaces of the central part 13, facing the hoistway 15. In the example shown in FIG. 5, the door 11 is located in the y-z surface in the x-axis positive direction of the central part 13. If the elevator has two entrances, it is possible to add a door to the y-z surface in the x-axis negative direction of the central part 13. It is possible to place wires such as cables in the wall of the central part 13.

The upper part 14 is located above (z-axis positive side) the room of the cage 10. The central part 13 has some space within the interior which enables the installation of various devices. The devices that are located in the upper part 14 can be electrically connected to the device located in the bottom part 12 via cables wired within the walls.

In the following, the bottom of the cage means the bottom part 12. The ceiling of the cage means the upper part 14.

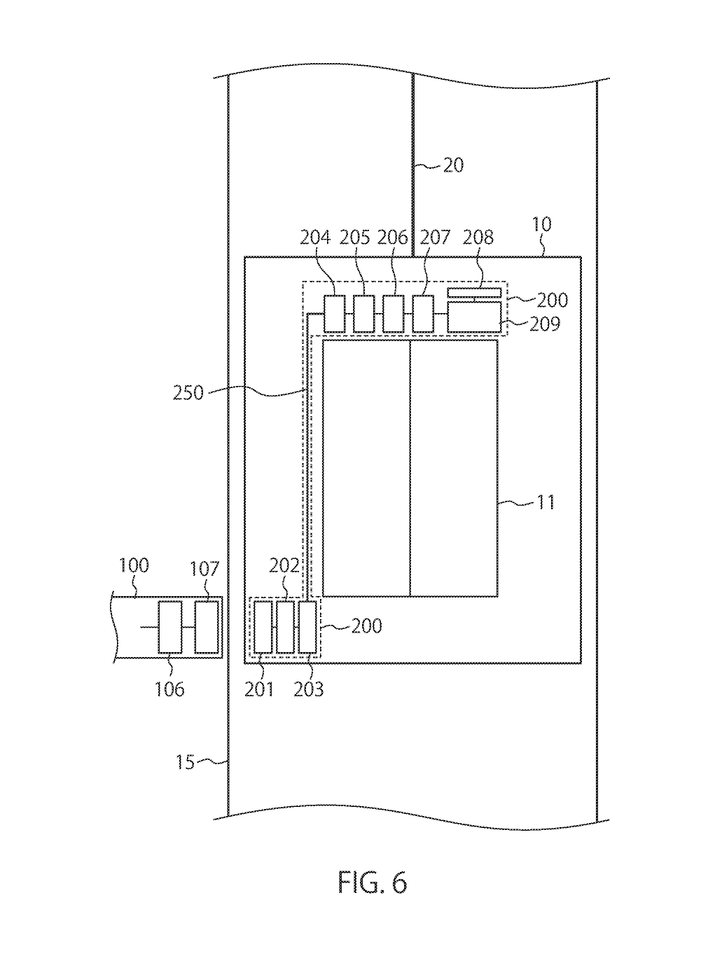

FIG. 6 is diagram showing a configuration of the elevator cage according to the first embodiment. FIG. 6 shows an example of the locations of each component corresponding to the power receiving device 200, within the cage 10.

In FIG. 6, the power receiving pad 201 of the power receiving device 200 is located in the bottom part 12. The power transmission pad 107 of the power transmission device 100 is located in the inner circumference of the hoistway 15, facing the power receiving pad 201. If process of wireless power supply is executed when the cage 10 is at the stopping locations, the pair formed by the power transmission pad 107 and the power receiving pad 201 is located under the feet of the passengers. Thus, the leakage electromagnetic field during the process of wireless power supply can be isolated from the heads of the passengers. By reducing the exposure of electromagnetic waves to the brains of the passengers, it is possible to remove risks for the human body.

If the cage 10 is stopping in the first floor or the underground floors (the lowest floors in the hoistway 15), the risk of having the bottom part 12 inundated with water would be greater than that of the upper part 14. If heavy rain or flood disasters occur in the environment where the elevator is installed, the bottom part 12 may be inundated relatively easily, even with low levels of water. If the battery 209 is located in the bottom part 12, problems such as leakage of electricity, short circuits or the like may occur as the result of flooding. To prevent such risks, the battery 19 is located in the upper part 14, for the power receiving device 200 according to the embodiment.

The specific locations of the elements belonging to the power receiving device 200 in the example illustrated in FIG. 6 are described below. The power receiving pad 201, the compensation capacitor 202 and the filter 203 are located in the bottom part 12. The rectifier circuit 204, the DC-DC converter 205, the backflow prevention diode 206, the switch 207, the monitoring unit 208 and the battery 209 are located in the upper part 14.

The components located in the bottom part 12 and the upper part 14 are electrically connected via a power cable 250. In the example shown in FIG. 6, the filter 203 and the rectifier circuit 204 are connected electrically with the power cable 250. Thus, AC power flows in the power cable 250 in the embodiment.

The compensation capacitor 202 is located before the filter 203, in the bottom part 12. The values of voltage and current of AC power provided from the power receiving pad 201 to the compensation capacitor 202 becomes lower in the output of compensation capacitor 202. If the filter 203 is omitted or if the filter 203 is located in a different place, it is possible to connect the compensation capacitor 202 to the rectifier circuit 204 using the power cable 250.

Depending on the configuration of the cage 10, the length of the power cable 250 may become long. Thus, in order to prevent drastic increase in overall weight of the cage 10, a light-weighed power cable should be used. If the voltage and current of the AC power is lowered, as it is the case in the embodiment, the use of cables with large allowable current values, large voltage ratings and large cross-sectional areas becomes no longer necessary. Thus, for the power cable 250, it is possible to use relatively inexpensive and light-weighed cables. Also, if the power cable 250 is long, the electromagnetic noise emitted from the cable becomes an issue. If the voltage and current of the AC power is lowered, as it is the case in the embodiment, the amount of electromagnetic noise emitted from the cable could be reduced.

It is possible to use a shielded cable as the power cable 250, for example. By using shielded cables, it is possible to reduce the amount of electromagnetic noise which is emitted. Also, by using shielded cables with multiple cores, it is possible to reduce the AC resistance of the power cable 250, thereby enabling efficient transmission of electric power. Below, a shielded cable with ten cores is explained as an example.

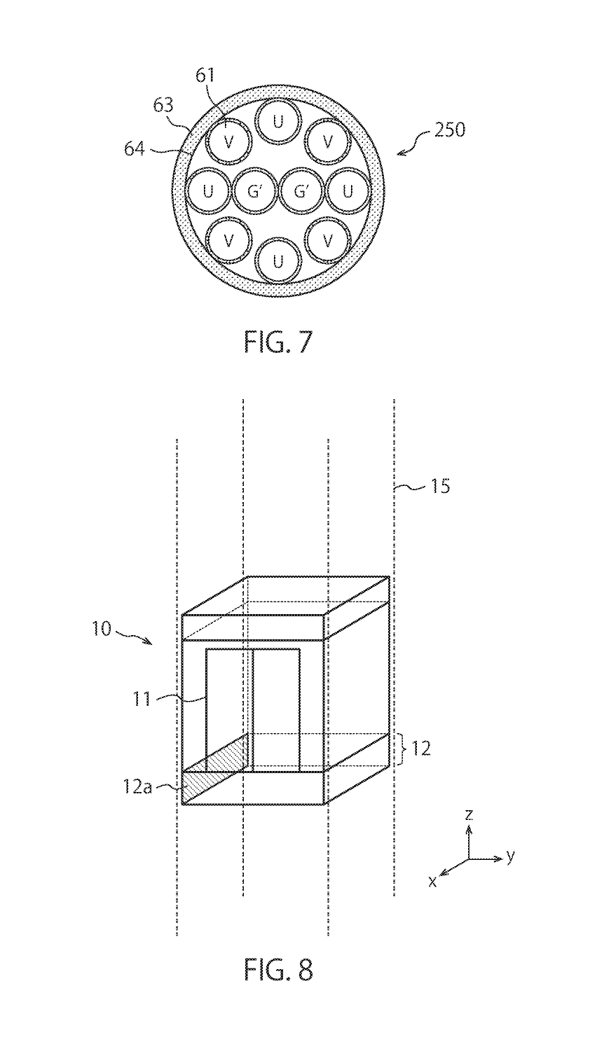

FIG. 7 is a cross-sectional diagram showing an example of the power cable 250. As shown in FIG. 7, the power cable 250 includes a core wire 61, an insulating coat 62, a sheath 63 and a shield 64.

The insulating coat 62 is covering the outer circumference of each core wire 61. The insulating coat 62 is formed with insulators. Examples of insulators include polyvinyl chloride, polyethylene, fluorine resin and polyester. However, other materials can be used. The insulating coat 62 insulates the gaps between the core wires 61.

The sheath 63 wraps the exterior of the power cable 250. The sheath 63 surrounds the whole set of core wires 61. The sheath 63 is formed with insulators. The sheath 63 is formed with insulators. Examples of insulators include polyvinyl chloride, polyethylene, fluorine resin and polyester. However, other materials can be used. The sheath 63 improves the insulation, the mechanical strength, corrosion resistance, heat-resistance, waterproof performance or the like of the power cable 250.

The shield 64 is a metal foil located in the inner wall of the sheath 63. All the core wires 61 are surrounded by the shield 64. By placing the shield 64, it is possible to reduce the impact of external noise to the core wires 61. The power cable 250 with the shield 64, as shown in the example of FIG. 7 is called a shielded cable. The power cable 250 according to the embodiment does not necessary have to be a shielded cable.

Next, the locations of the core wires 61 in the embodiment are explained. In the embodiment, each core wire U is located so that they are adjacent to at least one core wire V. Similarly each core wire V is located so that they are adjacent to at least one core wire U. In the core wire U, the differential current of AC power flowing in the core wire V is flowing.

If the core wires 61 are allocated according to the aforementioned description, the region within the core wire U which is in the vicinity of the neighboring core wire V becomes the high density regions. The high density regions are regions with relatively high density of current. Due to the proximity effect, the current flowing in the core wire U is concentrated in regions close to the core wire V.

Similarly, the region within the core wire V which is in the vicinity of the neighboring core wire U becomes the high density regions. Due to the proximity effect, the current flowing in the core wire V is concentrated in regions close to the core wire U.

As a result, it is possible to form high density regions in all the core wires U and V. The total area of the high density regions in this case would be greater compared to cases where the core wire U and core wire V are not located adjacently. The larger the high density regions are, the lower the AC resistance become. Thus, it is possible to reduce the AC resistance by using the aforementioned allocation of core wires.

Also, it is desirable to have the core wire U and the core wire located alternately. Then, it is possible to form two high density regions in each core wire U and core wire V, increasing the total area of the high density regions and reducing the AC resistance of the power cable 250.

The power cable 250 shown in FIG. 7 is a ten-core cable including ten core wires 61. Out of the ten core wires 61, four are core wires U connected to the first terminal. Another four are core wires V connected to the second terminal. The remaining two are core wires G′ which are grounded. The core wires G′ are located in the center of the power cable 250. The core wires U and V are located in the periphery of the core wires G′, alternately. In the power cable 250 shown in FIG. 7, two high density regions are formed in each of the core wires U and the core wires V.

Next, the surface where the power receiving pad 201 is located is explained. FIG. 8 to FIG. 10 are perspective diagrams which show examples of the surfaces where the power receiving pad 201 is located. The power receiving pad 201 is located in the outer circumference of the bottom part 12, facing the hoistway 15.

In the example shown in FIG. 8, the power receiving pad 201 is located along the surface 12a. The surface 12a corresponds to the z-x surface in the y-axis negative side of the bottom part 12. In this case, the power transmission pads 107 are placed in locations of the hoistway 15 which faces the surface 12a.

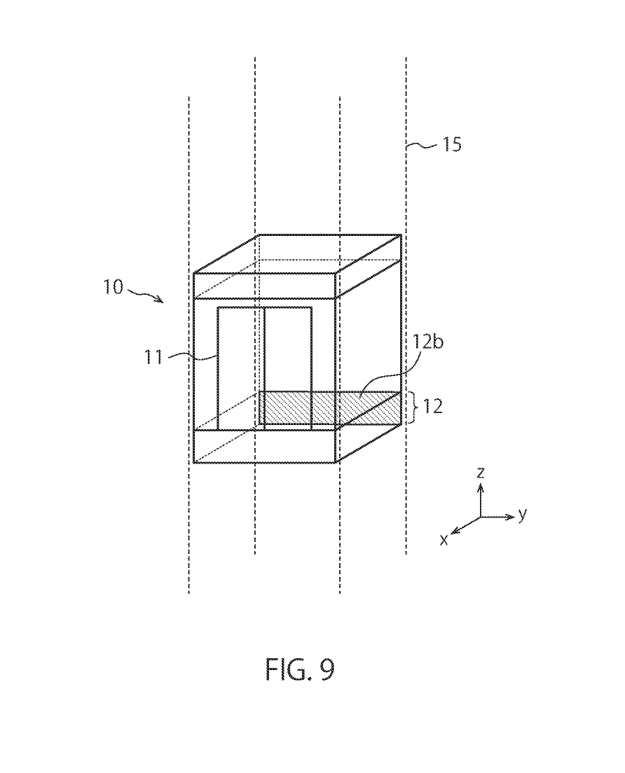

In the example shown in FIG. 9, the power receiving pad 201 is located along the surface 12b. The surface 12b corresponds to the y-z surface in the x-axis negative side of the bottom part 12. In this case, the power transmission pads 107 are placed in locations of the hoistway 15 which faces the surface 12b.

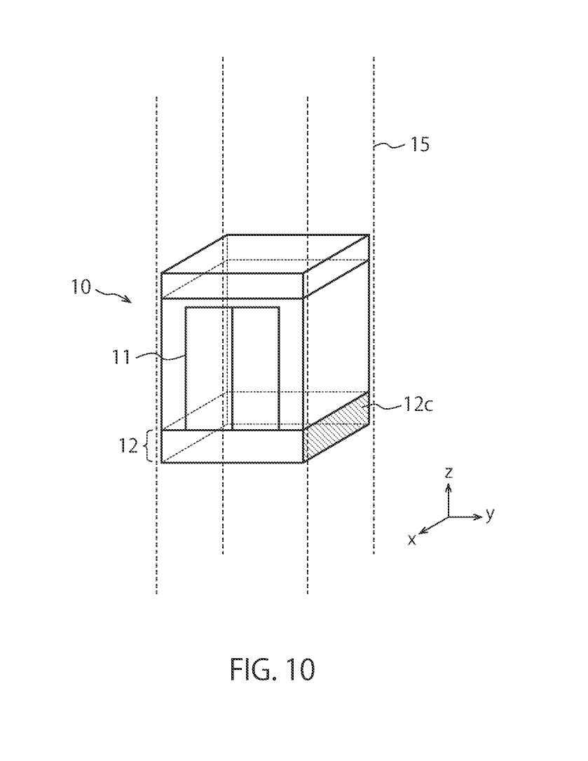

In the example shown in FIG. 10, the power receiving pad 201 is located along the surface 12c. The surface 12c corresponds to the z-x surface in the y-axis positive side of the bottom part 12. In this case, the power transmission pads 107 are placed in locations of the hoistway 15 which faces the surface 12c.

In the aforementioned examples, the y-z surface in the x-axis positive side which is the same surface as the door 11 was not mentioned as the locations for placing the power receiving pad 201. Regarding the surface of the cage 10 where the door 11 is located, passengers and goods traverse the surface when entering and exiting the cage 10. Thus, there are risks of having some objects intruding into the gap between the hoistway 15 and the cage 10. Depending on the sizes and materials of the intruding objects, short currents between the power transmitting pad 107 and the power receiving pad 201 may occur. Also, abnormally high temperatures may occur. Therefore, considering the safety, it is desired to have the power transmitting pad 107 and the power receiving pad 201 located in surfaces where the door 11 is not located.

In above, an example when the power receiving pad 201 is located on a surface of the bottom part 12 facing the hoistway was explained. However, the power receiving pad 201 can be placed in other locations as well. For example, if types of wireless power supply which allow long distances between the power receiving pad and the power transmission pad including magnetic resonance are used, it is possible to locate the power receiving pad 201 in the interior of the bottom part 12. Thus, as long as the power receiving pad 201 is located in the bottom part 12, the location of the power receiving pad 201 is not limited.

Next, the configuration of the power transmission pad and the power receiving pad is described.

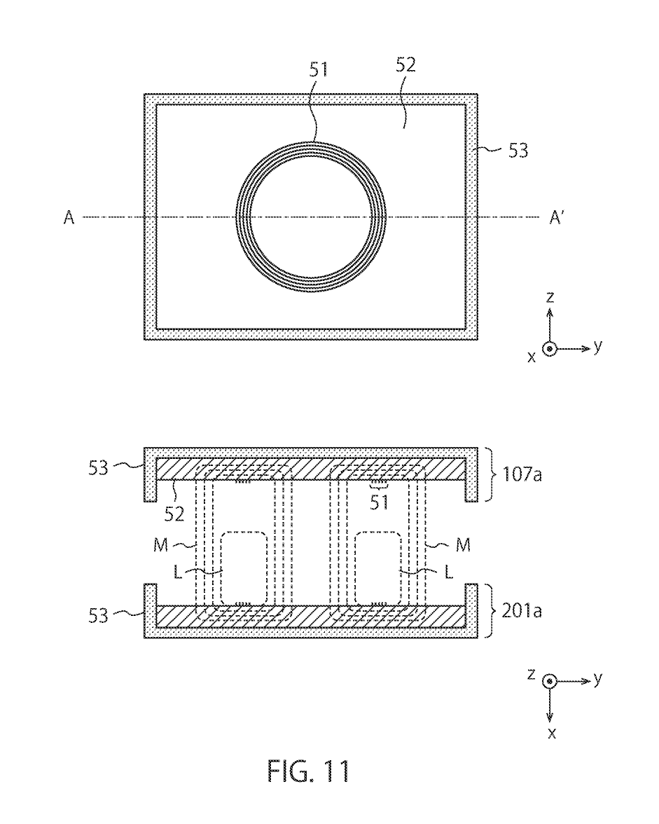

FIG. 11 is a diagram showing a first example of a power transmission pad and a power receiving pad. In FIG. 11, the coordinate axis shows the directions when the power receiving pad is located in surface 12b as shown in FIG. 9. The top of FIG. 11 shows a front view of a power transmission pad 107a from the side where it faces a power receiving pad 201a. Since the structure of the power transmission pad 107a and the power receiving pad 201a are symmetrical, it can be said that the top of FIG. 11 is also a diagram which shows a front view of the power receiving pad 201a from the side where it faces the power transmission pad 107a. The bottom of FIG. 11 is a cross-sectional diagram which shows the power transmission pad 107a and the power receiving pad 201a cut by the x-y plain which passes the line AA′.

The power transmission pad 107a includes a coil 51, a core 52 and a conductor 53. The coil 51 forms a winding which is approximately circular-shaped, on the surface of the core 52. The coil 51 shown in FIG. 11 is called a spiral coil. The winding can be formed with litz wires, bus bars or the like, for example. For materials of the winding, it is possible to use metals such as copper, for example. However, as long as the material is conductive, any material can be used. The core 52 is an approximately board-shaped magnetic core formed with magnetic substances such as iron oxide, chromium oxide, cobalt, ferrite or the like, for example. The type of magnetic substances which is used is not limited.

The conductor 53 is a metal shield which shields magnetic fluxes formed with metals such as iron or the like. The conductor 53 covers the side which is in the opposite side of the coil 51 of the core 52, for example. Thus, it is possible to reduce leakage magnetic fluxes to the back (x-axis negative side) of the power transmission pad 107a. Also, the conductor 53 can have a wall structure which surrounds the circumference of the core 52, as shown in the bottom of FIG. 11. By using a wall structure, it is possible to reduce leakage magnetic fluxes to the direction of the x-axis and the y-axis. The surfaces which are shielded with the conductor 53 correspond to the surfaces that do not face the power receiving pad 201a in the power transmission pad 107a.

Here, the structure of the power transmission pad 107a was described. The structure of the power receiving pad 201a is as the same as the structure of the power transmission pad 107a.

In the bottom of FIG. 11, the power transmission pad 107a and the power receiving pad 201a which are paired during the wireless power supply process is shown. The broken lines M in the bottom of FIG. 11 show the main magnetic fluxes. Regarding the main magnetic fluxes, the magnetic fluxes are connected between the coil 51 of the power transmission pad 107a and the coil 51 of the power receiving pad 201a. The broken lines L in the bottom of FIG. 11 show the leakage magnetic fluxes. The leakage magnetic fluxes only surround either of the coils 51. Thus, the leakage magnetic fluxes are not connected between the two coils 51. For the example shown in FIG. 11, the greater the number of main magnetic fluxes there are, the stronger the electromagnetic coupling between the power transmission pad 107a and the power receiving pad 201a becomes.

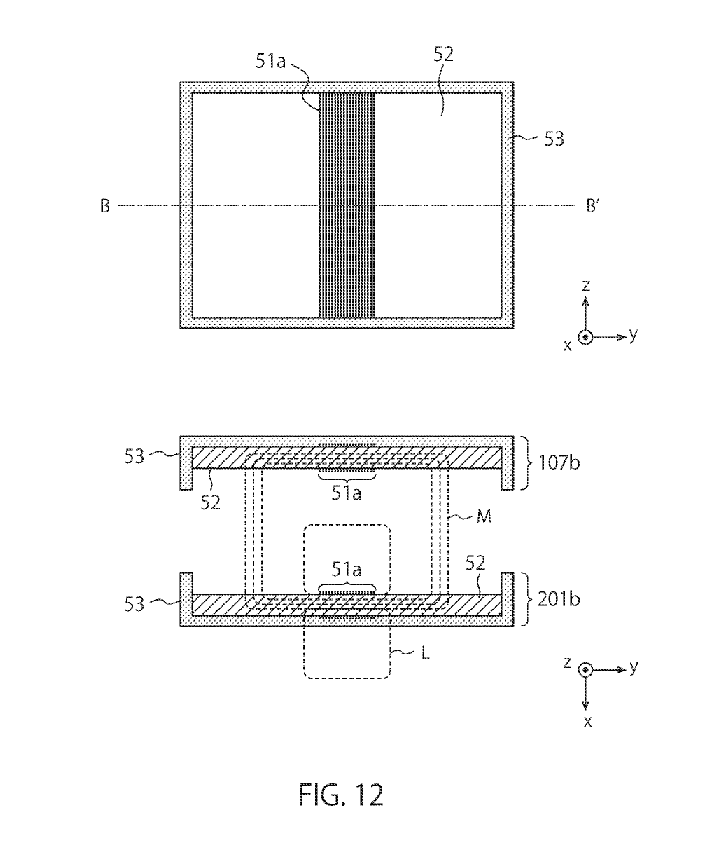

FIG. 12 is a diagram showing a second example of a power transmission pad and a power receiving pad. In FIG. 12, the coordinate axis shows the directions when the power receiving pad is located in surface 12b as shown in FIG. 9. The top of FIG. 12 shows a front view of a power transmission pad 107b from the side where it faces a power receiving pad 201b. Since the structure of the power transmission pad 107b and the power receiving pad 201b are symmetrical, it can be said that the top of FIG. 12 is also a diagram which shows a front view of the power receiving pad 201b from the side where it faces the power transmission pad 107b. The bottom of FIG. 12 is a cross-sectional diagram which shows the power transmission pad 107b and the power receiving pad 201b cut by the x-y plain which passes the line BB′.

In FIG. 12, a coil 51a of the power transmission pad 107b which is wounded on the core 52 is shown. The coil 51a is a solenoid coil. Except the fact that the type of coil used is different, the structure of the power transmission pad 107b is similar to the example shown in FIG. 11. Here, the structure of the power transmission pad 107b was explained. However, the structure of the power receiving pad 201b is the same as the power transmission pad 107b due to symmetry.

As described in the embodiment, if approximately board-shaped power transmission pads and power receiving pads are used, the restrictions for installing elevators are alleviated, compared to cases when power transmission pads with complicated shapes are used. The power transmission pads and the power receiving pads described in above are only examples. Therefore, it is possible to use power transmission pads and power receiving pads with different structures.

By applying the non-contact charging system according to the embodiment to elevators, it is possible to make the elevators wireless while maintaining the safety and keeping costs low. Then, it is possible to prevent the usage of heavy tail cords in elevator systems. By using lighter and inexpensive tail cords, it is possible to reduce the consumption of energy, construction costs and the difficulty of maintenance.

In above, different components that prevent the backflow of current from the battery 209 to the direction of the power receiving pad were described for the power receiving device 200. Examples of such components include the rectifier circuit 204, the backflow prevention diode 206, the switch 207 and the monitoring unit 208. It is possible to omit some of the above components in the actual implementations. However, for the sake of safety, it is desired that the non-contact charging system has at least one of the above mentioned components for preventing the backflow of current.

### Second Embodiment

In the first embodiment, the power receiving pad 201, the compensation capacitor 202 and the filter 203 were located in the bottom part 12 of the cage. The rectifier circuit 204, the DC-DC converter 205, the backflow prevention diode 206, the switch 207, the monitoring unit 208 and the battery 209 were located in the upper part 14 of the cage. However, the above is only an example of allocation of components. As long as the power receiving pad 201 is located in the bottom part 12 and the battery 209 is located in the upper part 14, it is possible to locate the components of the power receiving device 200 differently.

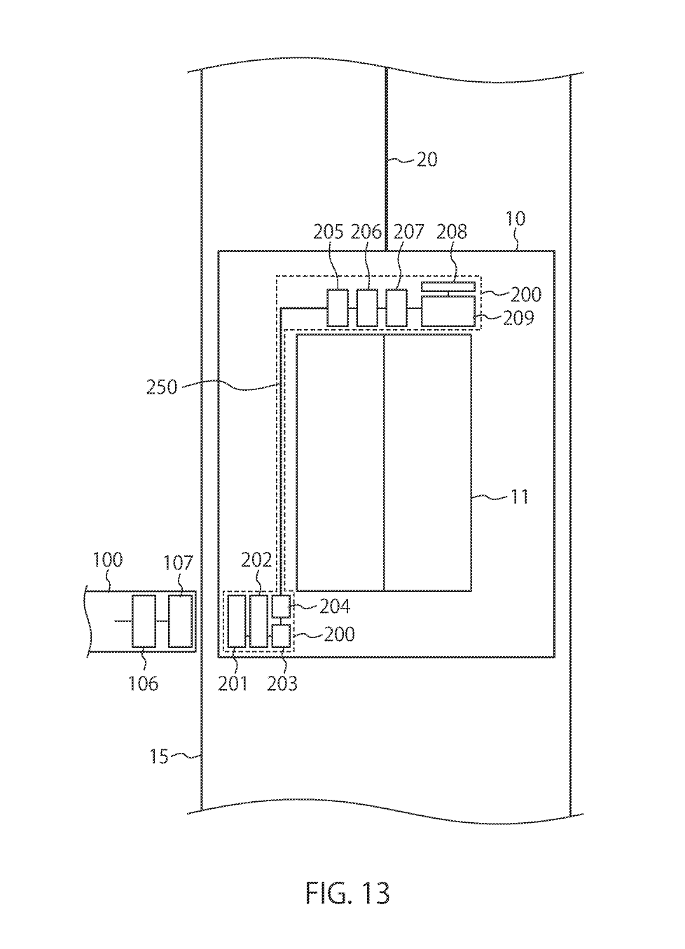

FIG. 13 is a diagram showing a configuration of an elevator cage according to a second embodiment. In the following, the differences from the first embodiment are described in reference to FIG. 13.

In the non-contact charging system according to the second embodiment, the rectifier circuit 204 is located in the bottom part 12 of the cage, not the upper part 14. In the embodiment, DC power flows in the power cable 250 which is electrically connecting the bottom part 12 and the upper part 14. If power is transmitted with direct currents (DC), it is possible to use cables that are less expensive compared to cases when alternating currents (AC) are used. Also, DC power transmission has merits such as low loss, low noise or the like.

Thus, by using the second embodiment, it is possible to lower the cost and the weight of the power cable 250. Also, it is possible to reduce the consumption of energy and the emitted electromagnetic noise. The rectifier circuit 204 in the first embodiment prevented the backflow of current when the bottom part 12 of the cage is inundated with water. Thus, if the rectifier circuit 204 is located in the bottom part 12 of the cage, the rectifier circuit 204 will be inundated, preventing the rectifier circuit 204 from acting as a backflow prevention component in the electric circuit. Therefore, if the second embodiment is used, components such as the backflow prevention diode 206, the switch 207 and the monitoring unit 208 should be located in the upper part 14 of the cage, to ensure that backflow of current is prevented in the electric circuit.

The features and the configuration of other components in the embodiment are similar to that of the non-contact charging system according to the first embodiment.

### Third Embodiment

In the description above, possibilities of having objects intruding between the power transmission pad and the power receiving pad, causing short currents and abnormally high temperatures were explained. Even if the power transmission pad and the power receiving pad are located in sides where the door is not located, there are still some risks of having some objects intruding between the pads. In the third embodiment, further measures are taken to prevent the intrusion of external objects.

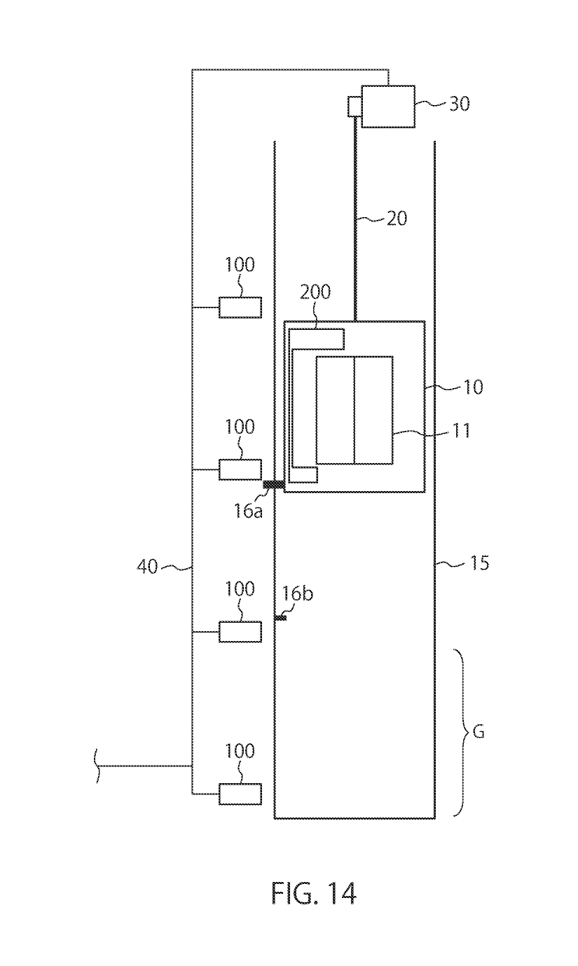

In FIG. 14, a diagram showing a configuration of a non-contact charging system according to a third embodiment is shown. In the non-contact charging system according to the embodiment, brushes are located in the vicinity of the power transmission pads and the power receiving pads. Then, it is possible to clean the power receiving pads and the power transmission pads with brushes. In the example shown in FIG. 14, a brush 16a is located in the vicinity of the power receiving pad of the cage 10. Also, a brush 16b is located in the vicinity of the power transmission pad of the hoistway 15. Regarding the brush 16a, the bristles are facing the exterior of the cage 10. Thus, it is possible to clean the power transmission pad when the cage 10 is in ascent or descent. Regarding the brush 16b, the bristles are facing the interior of the hoistway 15. Thus, it is possible to clean the power receiving pad when the cage 10 is passing.

In the example shown in FIG. 14, a single brush 16b is located. However, the number of brushes 16b could be greater. Also, the possible locations of the brush 16b are not limited. For example, the brush 16b can be located in all the stopping locations of the cage 10. Also, it is possible to place brushes only in the vicinity of the power transmission pads or the power receiving pads.

### Fourth Embodiment

Many elevator cages have devices for communicating with the outside. Communication includes the reception of control signals, transmission of videos taken by the surveillance cameras, communication of sound and transmission of status information related to the devices, for example. In order to use lighter tail cords or making the elevator cage wireless, it is desired to use wireless communication.

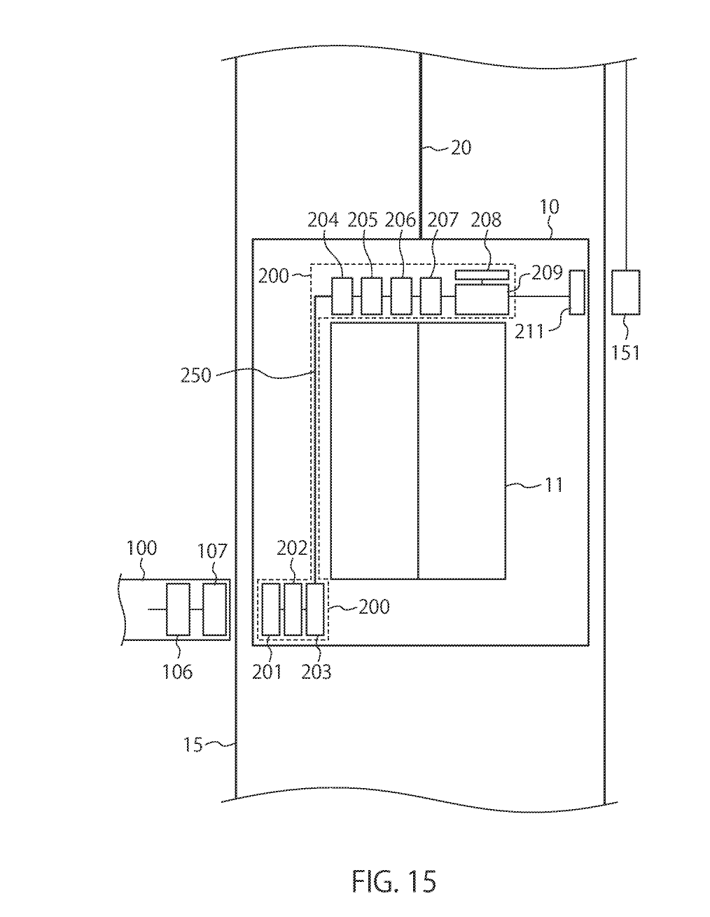

FIG. 15 is a diagram showing a configuration of an elevator cage according to a fourth embodiment. In the following, the differences from the above embodiments are explained in reference to FIG. 15.

If wireless communication devices are located in the cages of elevators, the electromagnetic noise generated by the non-contact charging system can interfere with the wireless communication. In order to prevent this problem, the wireless communication device is isolated from the source of noise, alleviating the impact from electromagnetic noises.

In the bottom of the cage 10, the receiving pad 201 which generates the strongest electromagnetic noise in the non-contact charging system is located. When the wireless power supply process is executed, the power transmission pad 107 is located in the vicinity of the power receiving pad 201. In the example shown in FIG. 15, the wireless communication device 211 on the cage 10 is located in the upper part of the cage. Since the wireless communication device 211 is isolated from major sources of electromagnetic noise, it is possible to maintain high communication qualities even when the wireless power supply process is executed.

A wireless communication device 151 is located in the inner circumference of the hoistway 15, facing the wireless communication device 211. Therefore, the wireless communication device 151 is located in the opposite side of the surface where the power transmission pad 107 is located in the hoistway 15. Therefore, regarding the wireless communication device 151, the impact of the electromagnetic noise generated by the power transmission pad 107 and the power receiving pad 201 are alleviated, maintaining high communication qualities.

The wireless communication device 211 can operate with the electric power provided from the battery 209. Also, the communication standards used by the wireless communication device 151 and the wireless communication device 211 are not limited.

### Fifth Embodiment

The location of the wireless communication device described in the fourth embodiment is only an example. In the embodiment, cases when the wireless communication device on the cage cannot be located in the upper part due to restrictions in space are explained.

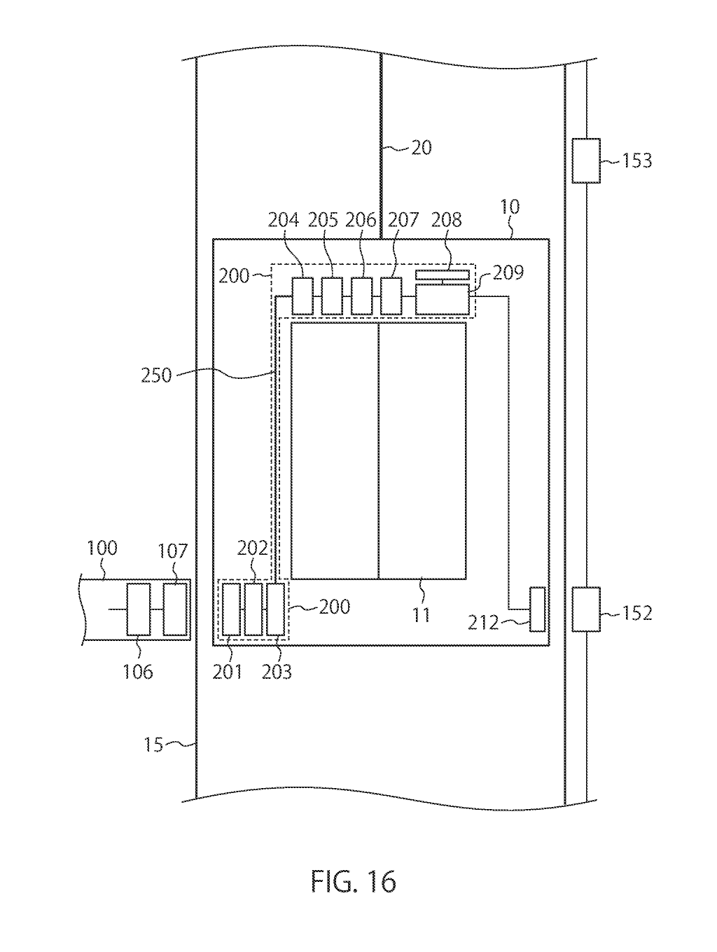

FIG. 16 is a diagram showing a configuration of an elevator cage according to a fifth embodiment. In the following, the differences from the embodiments explained above are described in reference to FIG. 16.

In the example shown in FIG. 16, a wireless communication device 212 is located in the bottom part of the cage 10. Also in the bottom part of the cage 10, the power receiving pad 201 which is the strongest source of electromagnetic noise in the non-contact charging system is located. When the wireless power supply process is executed, the power transmission pad 107 is located in the vicinity of the power receiving pad 201.

In this case, the wireless communication device 212 is located in a location which is isolated from the sources of electromagnetic to the horizontal direction. The wireless communication device 212 in the example shown in FIG. 16 is located in the opposite side of the power receiving pad 201. Therefore, it is possible to reduce the impact of electromagnetic noise to wireless communication. The wireless communication devices 152 and 153 are located in the inner circumference of the hoistway 15, facing the wireless communication device 212. Therefore, the wireless communication devices 152 and 153 are also located in the opposite side of the side where the power transmission pad 15 is located in the hoistway 15. Thus, regarding the wireless communication devices 152 and 153, the impact of the electromagnetic noise generated in the power transmission pad 107 and the power receiving pad 201 are alleviated, maintaining the high communication qualities.

As shown in the example of FIG. 16, a plurality of wireless communication devices can be located along the hoistway. Also the heights where the wireless communication devices are located in the hoistway are not limited.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A non-contact charging system for an elevator comprising:
a secondary battery located in an upper part of a cage; and
a power receiving pad located in a bottom part of the cage; and
a rectifier circuit connected between the power receiving pad and the secondary battery; and
a first capacitor connected between the power receiving pad and the rectifier circuit, located in the bottom part of the cage.

2. The non-contact charging system for an elevator according to claim 1, wherein
the power receiving pad is facing one of the surfaces in a hoistway.

3. The non-contact charging system for an elevator according to claim 2, further comprising
a power transmission pad located in the hoistway, facing the power receiving pad; and
a second capacitor connected between the power transmission pad and a AC power supply.

4. The non-contact charging system for an elevator according to claim 3, wherein
the power transmission pad is located in stopping locations of the cage in the hoistway.

5. The non-contact charging system for an elevator according to claim 3, further comprising
spiral coils which are approximately circular-shaped wirings, each located on a first surface of an approximately board-shaped magnetic core of the power transmission pad, facing the power receiving pad and a second surface of an approximately board-shaped magnetic core of the power receiving pad, facing the power transmission pad; and
metal shields each located on a third surface of the power transmission pad which does not face the power receiving pad and a fourth surface of the power receiving pad which does not face the power transmission pad.

6. The non-contact charging system for an elevator according to claim 3, further comprising
solenoid coils each wounded on approximately board-shaped magnetic cores of the power transmission pad and the power receiving pad; and
metal shields each located on a third surface of the power transmission pad which does not face the power receiving pad and a fourth surface of the power receiving pad which does not face the power transmission pad.

7. The non-contact charging system for an elevator according to claim 3, further comprising
a first wireless communication device located in an outer circumference of the upper part of the cage; and
a second wireless communication device located in an inner circumference of the hoistway, facing the first wireless communication device.

8. The non-contact charging system for an elevator according to claim 3, further comprising
a first wireless communication device located in an opposite side of the power receiving pad, in the bottom part of the cage; and
a second wireless communication device located in an inner circumference of the hoistway, facing the first wireless communication device.

9. The non-contact charging system for an elevator according to claim 3, further comprising
a first brush located in vicinity of the power transmission pad in the hoistway, with bristles facing the interior of the hoistway.

10. The non-contact charging system for an elevator according to claim 3, further comprising
a second brush located in vicinity of the power receiving pad, with bristles facing the exterior of the cage.

11. The non-contact charging system for an elevator according to claim 1, further comprising
a backflow prevention unit located in the upper part of the cage, the backflow prevention unit connected between the rectifier circuit and the secondary battery.

12. The non-contact charging system for an elevator according to claim 11, wherein
the backflow prevention unit includes a backflow prevention diode.

13. The non-contact charging system for an elevator according to claim 11, wherein
the backflow prevention unit includes a switch.

14. The non-contact charging system for an elevator according to claim 13, wherein
the backflow prevention unit includes a monitoring unit, the monitoring unit manipulating the switch based on measurements from sensors.

15. The non-contact charging system for an elevator according to claim 14, wherein
the sensors include leakage water detectors located in the bottom part of the cage.

16. The non-contact charging system for an elevator according to claim 11, further comprising
a power cable located in walls of the cage and the power cable electrically connecting the rectifier circuit located in the bottom part of the cage and the backflow prevention unit.

17. The non-contact charging system for an elevator according to claim 1, further comprising
a power cable located in walls of the cage and the power cable electrically connecting the rectifier circuit located in the bottom part of the cage and the first capacitor.

18. The non-contact charging system for an elevator according to claim 17, wherein
the power cable is a shielded cable.

19. The non-contact charging system for an elevator according to claim 18, wherein
the power cable is a ten-core cable including at least four first core wires and at least four second core wires, and currents flowing in the first core wires are differential currents of currents flowing in the second core wires.

20. The non-contact charging system for an elevator according to claim 1, wherein
the power receiving pads are located in sides where a door of the cage is not located.
